(19) United States
(12) Patent Application Publication
(10) Pub. No.: US 2011/0270662 A1
(43) Pub. Date: Nov. 3, 2011

(54) SYSTEMS AND METHODS FOR MOBILE ORDER APPLICATIONS IN RETAIL ENVIRONMENTS

(76) Inventor: Leonardo Rocco, San Francisco, CA (US)

(21) Appl. No.: 13/035,851

(22) Filed: Feb. 25, 2011

Related U.S. Application Data
(60) Provisional application No. 61/308,277, filed on Feb. 25, 2010.

(51) Int. Cl. G06Q 30/00; G06Q 50/00; G06Q 99/00

(52) U.S. Cl. 705/14.27; 705/14.64; 705/26.8; 705/14.39; 705/319; 705/15

(57) ABSTRACT

Systems and methods for mobile order application in retail environments allow consumers to initiate orders for items (such as food or beverage) or other services on a venue's premises directly with a merchant via a smart phone. A venue's staff may immediately view and fulfill the order, which is made available for pickup or delivery based on a consumer's preference. A merchant may capitalize on demand during peak hours, optimize their workforce, and have access to consumer buying behavior and data to refine their product and service offerings. Consumers and vendors are also able to utilize on-premise social networking capabilities that allow people who are at the same venue to communicate with each other while at the venue. In addition, the mobile ordering application may leverage information from third party social networking sites. Merchants and advertisers may send real time suggestive advertising messages and digital gifts to potential customers to drive traffic to their venue(s).

### CROSS-REFERENCE

This application claims the benefit of U.S. Provisional Application No. 61/308,277, filed Feb. 25, 2010, which application is incorporated herein by reference in its entirety.

### BACKGROUND

Restaurants, bars, coffee shops, and/or other food/beverage establishments often allow customers/patrons to place their food and/or beverage order at a counter. In such circumstances, an employee of the establishment interacts with the customer and enters the customer's order. As the number of employees working in the establishment at any one given time is limited, long lines may form at the counter when a large number of customers are attempting to order food and/or beverages. The orders are typically taken based on the position of each customer in the line. Accordingly, while the customers wait in line, they may be unable to perform other, more productive tasks. As such, if the lines appear to be too long, some customers may be dissuaded from frequenting the food/beverage establishment altogether.

In addition, the employee behind the counter may make a mistake in entering a customer's order. As such, the customer may receive one or more items that he did not order, and/or may not receive one or more items that he did order. This may result in customer dissatisfaction, and in some instances, illness. For example, a customer who is allergic to nuts may order an ice cream sundae without nuts. If the employee neglects to include this preference in entering the order, the customer may have an allergic reaction when the sundae is consumed. This may also result in reduced business, bad publicity, and/or loss of revenue for the restaurant.

In some instances, a number of customers may gather at the counter such that the employee behind the counter cannot discern the order in which the customers arrived. For example, at a bar/nightclub, multiple patrons may gather around the bar counter and attempt to place an order with the bartender. However, the bartender may not be able to tell which of the patrons arrived first. As such, orders may be taken out of order, and patrons may become impatient and/or otherwise dissatisfied with the bartender and/or the bar/nightclub. This may result in reduced tipping, loss of popularity, and/or reduced business, which may lead to a loss of revenue for the bar/nightclub.

Therefore, there is a need for improved systems and methods for improving customer services for consumers, by optimizing efficiency and maximizing revenue for merchants, while also providing real transactional data to an advertiser.

### SUMMARY

The invention provides systems and methods for mobile ordering applications in retail environments. Various aspects of the invention described herein may be applied to any of the particular applications set forth below. The invention may be applied as a standalone system or as a component of an integrated software solution for mobile ordering applications. The invention can be optionally integrated into existing business and processes seamlessly. It shall be understood that different aspects of the invention can be appreciated individually, collectively or in combination with each other.

In one aspect, a mobile application ordering system for processing orders at a retail venue is provided. The mobile application ordering system includes a consumer mobile application accessible through a consumer's mobile device for allowing a consumer to place an order for a retail item, and an administrative portal for allowing the retail venue to receive and process the order for the retail item from the consumer. The order may be transmitted from the consumer's mobile device to the administrative portal over a network. The consumer mobile application allows the consumer to communicate with at least one other consumer at the retail venue, and the administrative portal allows a representative from the retail venue to track data relating to the consumer's spending behavior.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an example of an architecture of a mobile application ordering system over a network, in accordance with embodiments of the present invention.

FIG. 2 illustrates a consumer's interaction with the mobile application ordering system, in accordance with embodiments of the present invention.

FIG. 3 illustrates an example for how orders may be processed in parallel, in accordance with embodiments of the present invention.

FIG. 4 illustrates features for consumers to communicate with other consumers at certain venues, in accordance with embodiments of the present invention.

FIG. 5 illustrates an example of a consumer's profile information in a mobile application ordering system, in accordance with embodiments of the present invention.

FIG. 6 illustrates an example of a communication display application, in accordance with embodiments of the present invention.

FIG. 7 illustrates an example of how an operator may complete multiple items via batch completion, in accordance with embodiments of the present invention.

FIG. 8 illustrates an example of a waiter or waitress application interface, in accordance with embodiments of the present invention.

FIG. 9 illustrates how a mobile ordering application system may also leverage information and features from various social networking sites, in accordance with embodiments of the present invention.

FIG. 10 illustrates an example of a manager application interface, in accordance with embodiments of the present invention.

FIG. 11 illustrates how an advertiser may utilize the mobile ordering application to create advertising campaigns at the point of purchase (such as brand interception), in accordance with embodiments of the present invention.

FIG. 12 illustrates how various types of users may interact with and utilize the mobile order system through various types of applications, in accordance with embodiments of the present invention.

### DETAILED DESCRIPTION

In the following detailed description, numerous specific details are set forth in order to provide a thorough understanding of the invention. However it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

Today, consumers may be forced to wait in lines and suffer from poor service anywhere merchants are unable to scale up staff to accommodate demand at densely populated venues. Further, limited timeframes for fulfilling orders may restrict the amount of goods that can be sold by a vendor, which may prevent a vendor from maximizing its revenue. In addition, merchants cannot effectively and efficiently monitor consumer loyalty and accurately calculate the lifetime value of their customers. For advertisers, tracking the exposure of ad campaigns and measuring the actual conversion rate of campaigns can be difficult, time consuming and expensive.

Embodiments of the present invention are directed towards methods and systems that are designed to improve customer service for consumers, by optimizing efficiency and maximizing revenue for merchants, while providing real transactional data to the advertiser, describing the effectiveness of ad campaigns, including with the ability to “intercept” a competitor's sale. In some embodiments, consumers can initiate an order on the premises of a merchant directly with the merchant via a smart phone, such as an iPhone, Blackberry, or Android mobile phone, and the order may immediately appears on a merchant's communication appliance, upon which the venue's staff can fulfill the order. The order may then be made available for pickup or delivery based on the consumer's preference.

With certain embodiments of the present invention, merchants may have burst capacity to capitalize on the total demand during peak hours. They can optimize their workforce for high value added activities (making/delivering goods) versus low value added activities (soliciting orders/processing payments). Merchants can sell more goods because consumers can place their order(s) and arrange payment via their mobile phone. In addition, both merchants and advertisers can have access to consumer “buying behavior” data to refine their product and service offerings. An on-premise social networking capability may also be provided that allows people who are at the same venue to be able to see and communicate with one another while at the same venue. Through the integration of social networking sites, for example Facebook (leveraging the Facebook API), merchants can see a complete view of their customer, tying together their profile information on the social networking site and their order history with the merchant (or with other merchants). Through a communication appliance, merchants may send real time suggestive advertising messages and digital gifts to their customers to drive traffic to their venue.

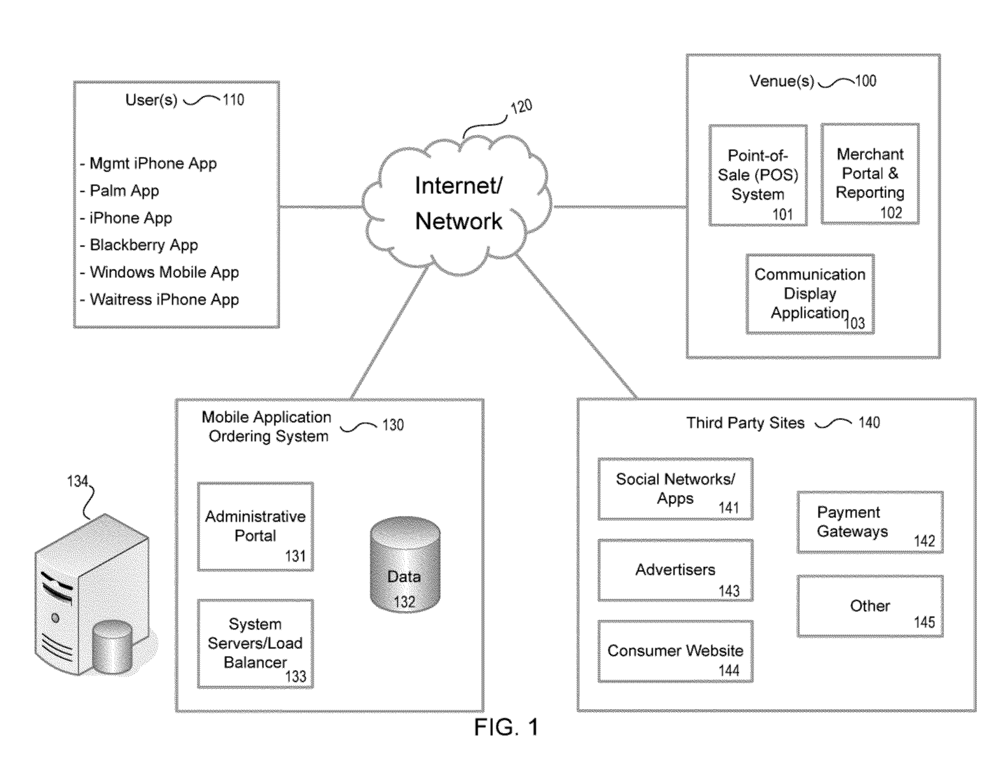

Referring to FIG. 1, a mobile application ordering system 130 may streamline the process of initiating and processing a retail transaction through a device of a user 110, such as the user's mobile phone. By initiating an order through a smart phone (a device that is able to connect to the internet via cell phone connection or wifi), a consumer 110 can initiate an order anytime, and not have to wait for staff at a venue 100. The venue 100 may receive the order through the vendor's communication appliance 103 and conduct the transaction through the venue's point of sale (POS) system 101. The user 110 may use the user's mobile device applications to communicate directly with the venue 100 over a network such as the Internet 120. The mobile application ordering system 130 may utilize an administrative portal 131 to administer the transactions. The administrative portal 131 may be coupled to a server and database 134. The administrative portal may also allow communication with social networking sites 141, financial institutions through payment gateways 142, advertisers 143 and consumer websites 144, or other third parties 145. The mobile application ordering system 130 may utilize load balancers, application servers, messaging servers, database servers or other servers to conduct the transactions described herein. A user's ordering history and other profile information, habits, characteristics or traits may be stored in data storage 132 or managed by certain system servers 133, and used to provide relevant and useful information to advertisers 143 or to merchants via the merchant portal and reporting module 102. The data may also be combined with relevant information obtained from third parties 140. For example, the consumer 110 may earn points on every purchase, creating and maintaining a status based on spend and visit history—and take that status with them, the ability to buy and gift credits to friends, and integrate their online social networking environment 141 with their on-premise social networking environment through an administrative portal 131.

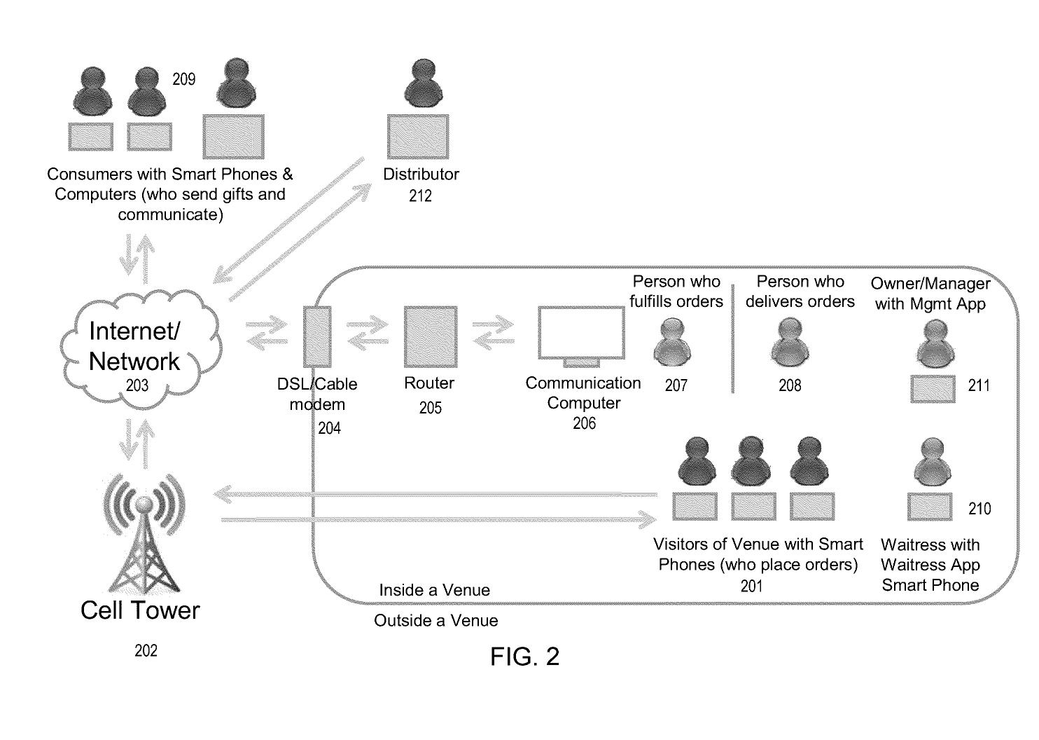

Referring to FIG. 2, a consumer's interaction with the mobile application ordering system is shown, in accordance with an embodiment of the invention. In FIG. 2, a visitor of a venue 201 may initiate an order by utilizing an application on a smart phone (or computer or other mobile device). The transaction may be communicated through a standard protocol of a cell phone tower 202, for example. The cell tower 202 may communicate the information over a network such as the Internet 203. A system server may receive the request and process the transaction accordingly. For example, the transaction may be a request for a glass of soda. The transaction may be communicated to the associated defined venue based on the request from the consumer, to a DSL/cable modem 204, which may communicate to the router 205, which may then communicate to a display computer 206 and display the request to a person at the venue who may be responsible for fulfilling orders 207. The person at the venue 207 may fulfill the order and may prepare the order and hand the order off to the person who delivers the order 208. The person who is responsible for delivering the order 208 may take the order and deliver it to the consumer 201 who had placed the order to begin with. Optionally, the consumer 201 may acknowledge receipt of the order by confirming the order in the consumer's mobile application using the consumer's mobile device.

In another scenario, a consumer 209 may use the mobile ordering application system to purchase an amount of credits and send the credits to a friend or other consumer. That friend may receive a notification that they have received the credits. The credits may be automatically deposited into the consumer's account. If consumer 201, for example, has received credits from another user, the consumer 201 may utilize those credits for making purchases. If consumer 209 purchases credits for a person who is not a user of the mobile ordering application system, the credits may be accompanied by an invitation to join. The friend may have the option to accept or ignore the invitation. If the consumer accepts, then the consumer may receive the credits which may be automatically deposited into the consumer's account and used for making purchases. The consumer 209 who has purchased credits for a friend may also receive a notification that the invitation has been accepted and that the credits have been deposited into their friend's account.

The mobile application ordering system may also provide benefits to a waitress 210 at the venue. For example, a waitress 210 may approach a consumer 201 to take a request for an order. The waitress 210 may enter the request of consumer 201 into the mobile ordering application. The person who fulfills the order 207 at the venue may receive the request on the communication computer 206. The person who fulfills the order 207 may then fulfill the order and hand off the order to the person who delivers the order 208. The person who delivers the order 208 may take the order and deliver it to the consumer 201.

Alternatively, a waitress 210 may approach consumer 201 to take his request for an order. The waitress 210 may use the mobile ordering application to enter consumer 201's request. Consumer 201 may enter a cell phone number that is associated with consumer 201's account or some other identifier into the waitress's device. Thus, the consumer 201 may be able to access and use any credits, points or other discounts and benefits that are associated with the consumer's account. Further, the consumer 201's purchase may be recorded in the consumer 201's history, and the consumer 201 may review this purchase through the mobile application or other device, such as the consumer's computer at home.

It should be understood that various other scenarios and series of events are made possible in accordance with embodiments of the invention. For example, consumer 209 may also be inside the same venue. Alternatively, the roles performed by waitress 210, the person who fulfills the order 207, and the person who delivers the order 208 may all be performed by the same person or by multiple people.

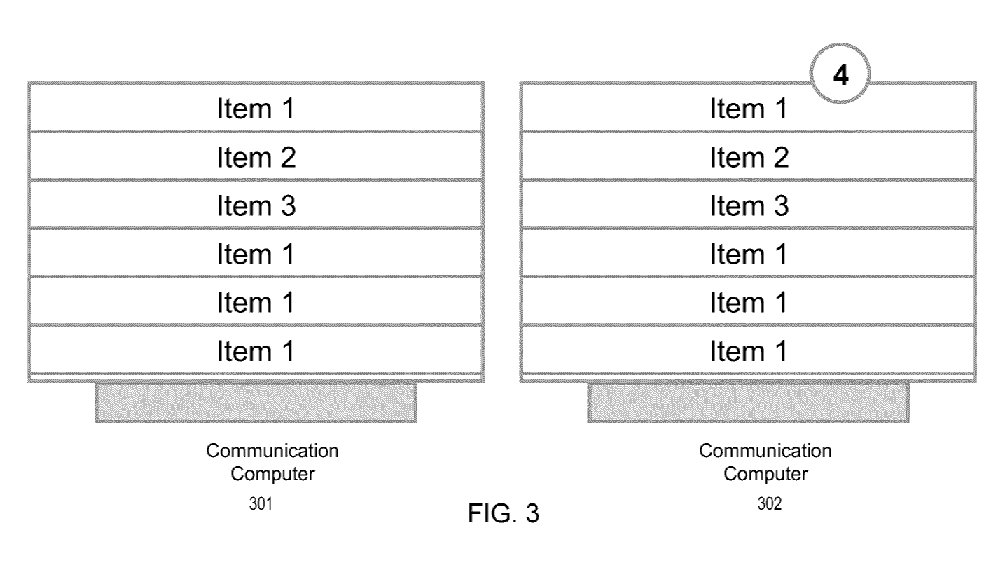

Referring to FIG. 3, the communication computers may receive orders for items in serial 301 but may process the items in a different order 302. For example, like orders may be matched, thus allowing a fulfiller to complete or fulfill all of those like items at once, which could make fulfilling orders more efficient.

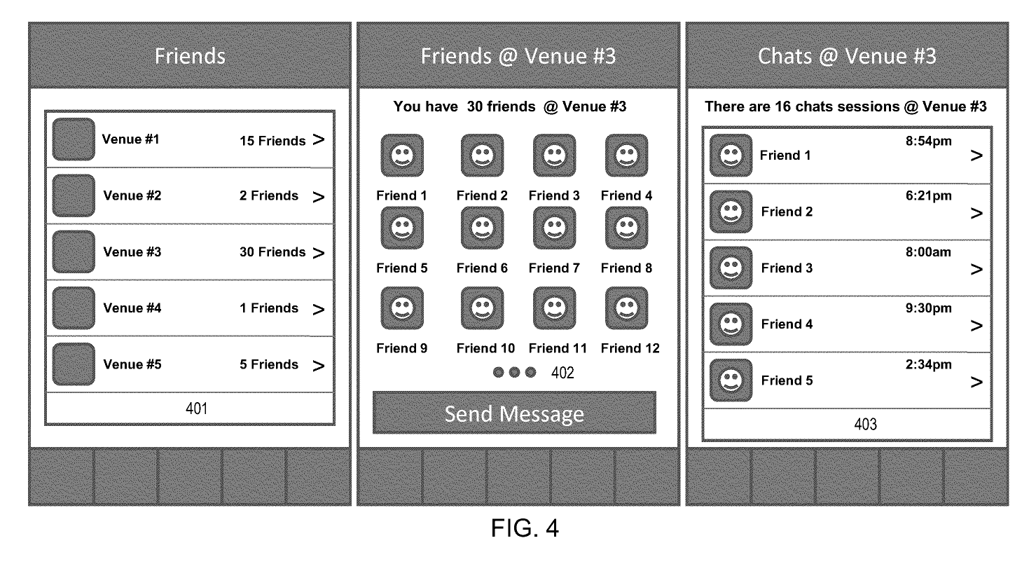

Referring to FIG. 4, consumers may have the benefit of better on-premise real time communication. For example, the system may provide a consumer with the ability to see how many of their friends within a certain social network are at which venues as in 401. The system may also provide a consumer with the ability to see who is currently located at a particular venue as in 402 so they can make better decisions on which venue they should visit. In this sense, a consumer may be able to see whether their friends are already at a certain venue, or can communicate with other users of the system. For example, a user may communicate with another user if they are at the same venue, for example, to ask whether the other user wants to share a cab or to invite the other user to an after party by sending the friend a message as in 401. Consumers may also be able to engage in chats with friends within a certain venue as in 403. For example, if the consumer has several ongoing chat sessions with a number of friends within a social network, the consumer may also view chats at a certain network all in one place as in 403.

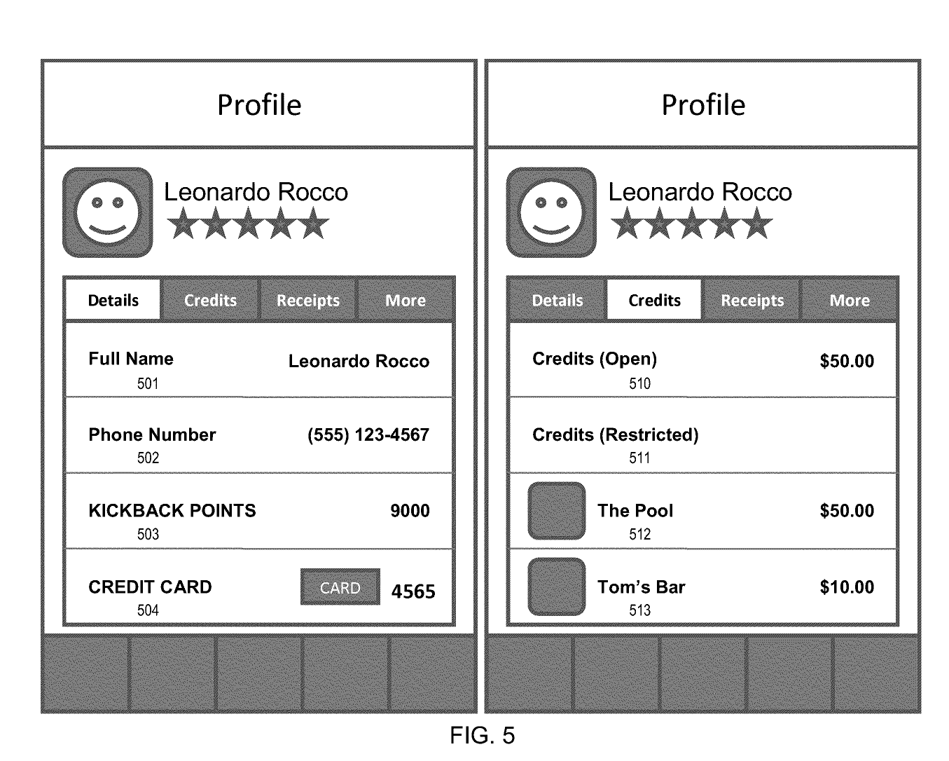

Referring to FIG. 5, a consumer's details and credits may also be displayed by the mobile application ordering system. For example, a consumer's name 501, phone number 502, points 503, or credit card information 504 may be stored as part of the consumer's profile. Further, consumers may have the ability to engage in virtual social gifting by sending gifts to friends on-premise at a venue and off-premise while the users are at home. In this way, a user may send a gift to a friend to recognize them or the fact that the user cannot be at the venue. For example, a user may be unable to attend a friend's birthday dinner or event. If the user wanted to send his/her friend a drink or buy his/her friend dinner, the user may be required to send or fax a photocopy of the user's credit card and driver's license to a representative of the venue, such as a manager, who could pass along the gift to the user's friend. That user would be risking exposure of his credit card and license information. Instead, the user may alternatively utilize the mobile application ordering system to send a virtual gift to his friend via the application which may be used by the friend to purchase food, beverage, or other goods or services. The gift may be in the form of a credit such as an open 510 or restricted credit 511. Open credits may be credits that are available for use at any venue, while restricted credits may be credits available only at particular venues or with other restrictions. A consumer's receipts or other information may also be stored.

Consumers may additionally participate in a loyalty program and earn points 503 for items purchased at a venue. In this manner, consumers may be awarded with certain benefits in return for the money that the consumer spends. Through the system, the consumer may combine points from various venues into one combined loyalty program and the system may keep track of the consumer's points and make it easy for the consumer to know how many points they have available and how the consumer may redeem them.

The consumer may also have access to certain electronic coupons through the mobile application ordering system. Whereas using traditional methods, consumers may misplace a coupon or rebate toward a discount on an item, a consumer instead may access coupons and discounts through their mobile device which they are likely to carry with them wherever they go. Thus, when a consumer earns points and want to use them at venues, instead of printing out a voucher or waiting to receive the voucher by mail, the consumer may simply redeem the points with the consumer's mobile device. This also eliminates the need for the consumer to remember to bring the voucher with them to the venue to redeem it and the need for the consumer to present it to the venue representative (waitress, etc). For example, if the consumer is on a special date or at a fancy restaurant, instead of having to present a waitress with a coupon, the system may automatically register that the consumer is eligible for an applicable discount.

Further, certain consumers seeking MMFI (make me feel important) may communicate their VIP status to a venue. Using traditional methods, when a consumer visits a venue, they may issue a gratuity to the representative at the door, a gratuity to the waitress and/or a gratuity to the bartender. The user may hope for improved service (e.g., to skip a line to get in, get served, etc.). Attrition, however, may be high for certain positions (door person, waitress, bartender) or at certain locations. As a result of attrition, there is a high probability that a consumer will not be a repeat consumer at certain venues. Using traditional methods, there is no simple and efficient way for these representatives (door person, waitress, bartender), to communicate to management who is visiting their venue—more importantly these representatives have no incentive to communicate to management the caliber or status of people that come into their venue. In addition, a specific consumer may be a big spender at the venue, however, because of the attrition problem the venue owner/management may not know this and the consumer may not be given preferential treatment based on the consumer's “big spender” status. Or the consumer could be a big spender at other venues, but the current venue that they are at may not know it.

Using embodiments of the present invention, however, an automated approach Customer Relationship Management (CRM) may be achieved. Venues may utilize historical or other information saved and made available by the mobile application ordering system to enhance the consumer's experience and increase the probability that a consumer will return to the venue. The venue may capture the specific consumer's experience and then follow up with that consumer and somehow motivate/incentivize them to come back. Having this capability allows the venue to drive the lifetime value of that specific consumer higher. For example, each week (or other week or month) a specific consumer may eat out and spend $100 on dinner. All restaurants within a certain proximity of the consumer may be competing for that consumer's business. A particular venue may utilize the mobile application ordering system to try to get that consumer to spend his $100 at that particular venue, and may want that particular consumer to spend $100 every week at that particular venue. Over a year, the venue may have an opportunity to make $5,200 from that consumer. Thus, the consumer, given his spending habits as stored on the mobile application ordering system, may no longer be just a $100 client. Instead, the consumer may be a $5,200 client.

Consumers may also utilize the mobile application ordering system to track their calorie intake. Through each transaction processed in which the consumer orders food or beverage, the items may be cross-referenced to a calorie database, where the nutritional facts may be pulled and computed in by the system. The consumer may enter their profile, which includes complete body information (height, weight, etc). This way, the system can recommend a diet that fits with their profile and suggest a venue, based on proximity to the consumer and suggest an item on the menu that fits within their current diet restrictions. For example, the system may store allergy information and suggest an item on the menu of a venue that will be consumable by the consumer. Additionally, the consumer may have certain weight loss goals, for example, and the system may recommend an appropriate diet, venue, item on a venue's menu, etc.

The mobile ordering and communication service may allow consumers at venues to order food and beverages on demand. Merchants may be able to sell more goods because consumers can place their orders and arrange payments via a mobile device, such as their mobile phones. Both merchants and advertisers may also have access to consumers' “buying behavior” data to refine their product and service offerings. In some embodiments, consumers may initiate an order directly with the merchant via mobile phone and arrange for either pickup or delivery with minimal assistance from a waitress or other representative of the merchant. Thus, merchants may have burst capacity to capitalize on the total demand of consumers during peak hours. Merchants may also optimize their workforce for high value added activities, such as making and delivering food and beverages, in comparison to low value added activities, such as soliciting orders and processing payments.

In some embodiments, the system may operate as a virtual waiter. Consumers may utilize the mobile application ordering system so that consumers will not have to wait for a waitress to place an order. Instead, consumers may place an order at any time. This may allow the venues to have a virtual waiter taking orders at anytime.

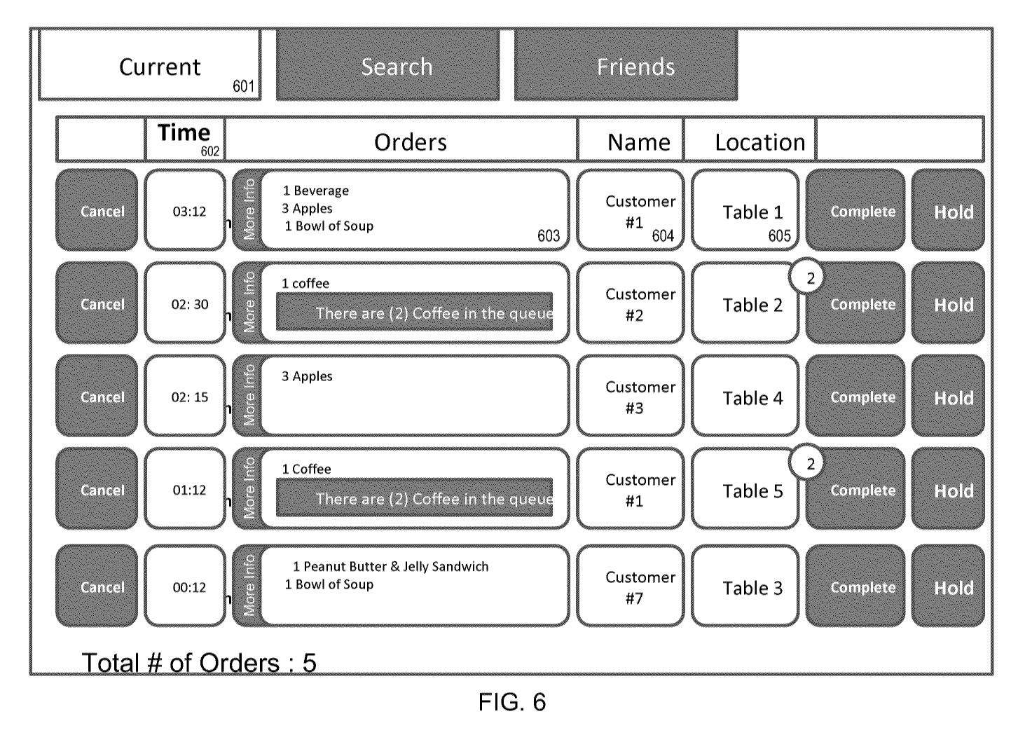

Referring to FIG. 6, an example of a communication display application is shown. The communication display application may show a list of current orders 601 as well as the time that has elapsed since each order was placed (or the time that each order was placed) 602, the contents of each order 603, the name of the customer who placed the order 604, and the customer's location 605. The person fulfilling the order may select “cancel” if an order is cancelled, “complete” if the order has been processed and delivered to the customer, or “hold” if the order processing must be paused for any reason.

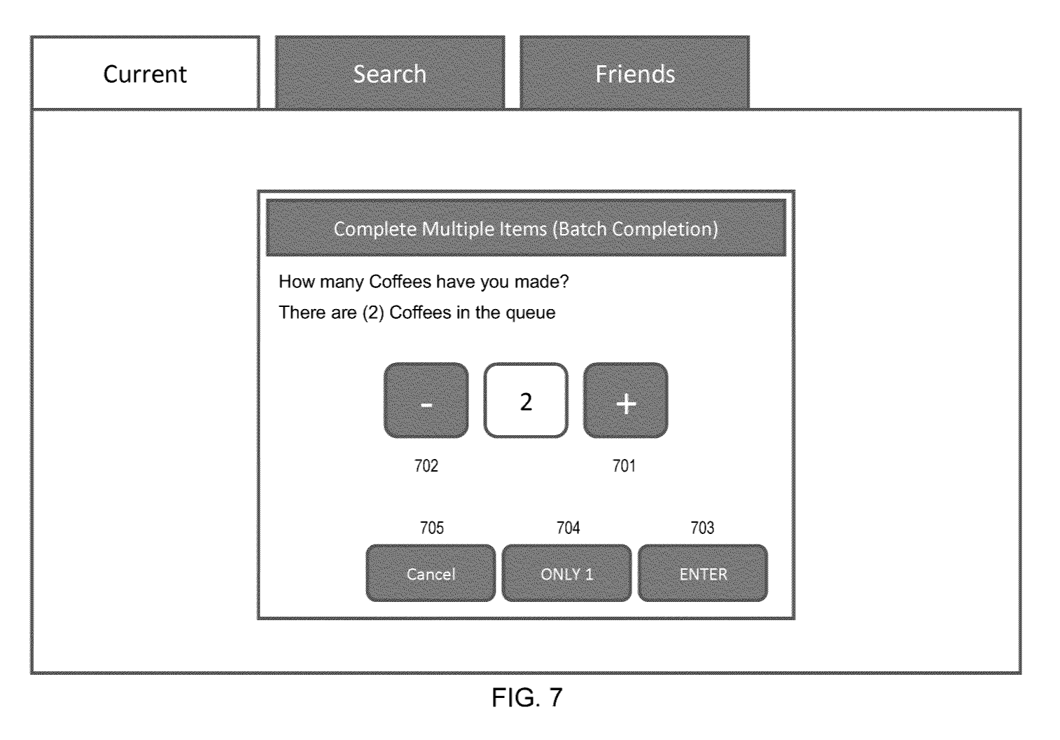

With a communication display application, a merchant may gain efficiency by utilizing batch fulfillment or an order aggregation feature. In FIG. 6, the system indicates that there are items that are repeated within the order queue (in the example shown, 2 coffees). Thus, the merchant may be able to gain efficiency by processing similar orders at the same time. For example, if there are 100 orders in the queue and there are 20 identical orders of diet coke in the queue at various points or order (an order for diet coke may be first in the queue and other orders for diet cokes may be tenth, fifteenth, etc). The system shows an alert where the operator can elect to make all orders for diet cokes at once. The operator may select a “complete” button on the merchant's display application and the system printer may print X number of paper receipts, representing each of the X number of orders for diet coke. For example, an operator may prepare 20 orders for diet coke all in a row and make them all at once. Referring to FIG. 7, an example of how an operator may complete multiple items via batch completion is shown. In FIG. 7 the operator may increase 701 or decrease 702 the number of items that the operator has completed. In addition, the operator may select “enter” 703 to indicate that he has completed a certain number of items, “cancel” to cancel the batch order completion, or “only 1” if the operator does not want to complete multiple items via batch completion. So rather than operating in typical serial method, the ordering application may provide the ability for the operator to process orders in parallel.

The mobile ordering application may also allow users to purchase tickets to gain entry to a certain venue, location or event. A consumer who is seeking entry to a venue may order and purchase their ticket using the mobile ordering application. The mobile ordering application may communicate with a venue representative who is responsible for venue entry and notify the representative that a ticket has been purchased and that a consumer may gain entry without having to use cash or other methods to purchase a ticket to gain entry. Thus, consumers may be able to enter into certain venues or events more quickly without requiring a cash transaction to take place.

In addition, the mobile ordering application may allow users to remove the requirement of cash transactions (or credit card transactions) by facilitating the transaction through the mobile device. Consumers may use their mobile devices to pay for items or services, and thus no physical cash or credit card may be required to make a purchase. This may also reduce the temptation of theft.

Consumers may also purchase credits via the mobile ordering application that can be used to purchase items at venues or from merchants. A merchant may also issue restricted credits which may be redeemed only at the venue which has issued them. A merchant may sell retail packages which may include both a ticket and a credit, for example, and may be able to define an expiration date on the usage of the credits. The credits may be associated with a ticketed event, for example, and may have an expiration date which applies after the event is over. For example, a venue may have a concert event, where the ticket may cost $50. With the cost of the ticket, they may include 10 credits toward the purchase of food and beverage. This may be a package and the ticket (credits included) may expire when the event is over. In addition, the merchant may have the ability, to have people pre-purchase credits for their use while at a venue and offer a deal such as “purchase $100 in credits for $50.” So, $50 may allow the consumer to purchase $100 worth of items offered at the venue. This offer may be associated with an event and the credits may have a defined expiration date. If a consumer purchases a ticket to a concert and decides not to go, they may or may not get a refund.

A retailer may also utilize a mobile ordering application to up-sell consumers or cross-sell items. In one embodiment, a retailer may define a rule that prompts the consumer with a message to “upgrade” the item they selected to another item. For example, if a consumer selects an 8 oz beverage, the system can suggest a 16 oz beverage for an incremental charge. In addition, the retailer can define a rule that prompts the consumer with a message to “associate/add” another item to the item they had selected. For example, if a consumer had selected a food item, the system may suggest adding a beverage with that item.

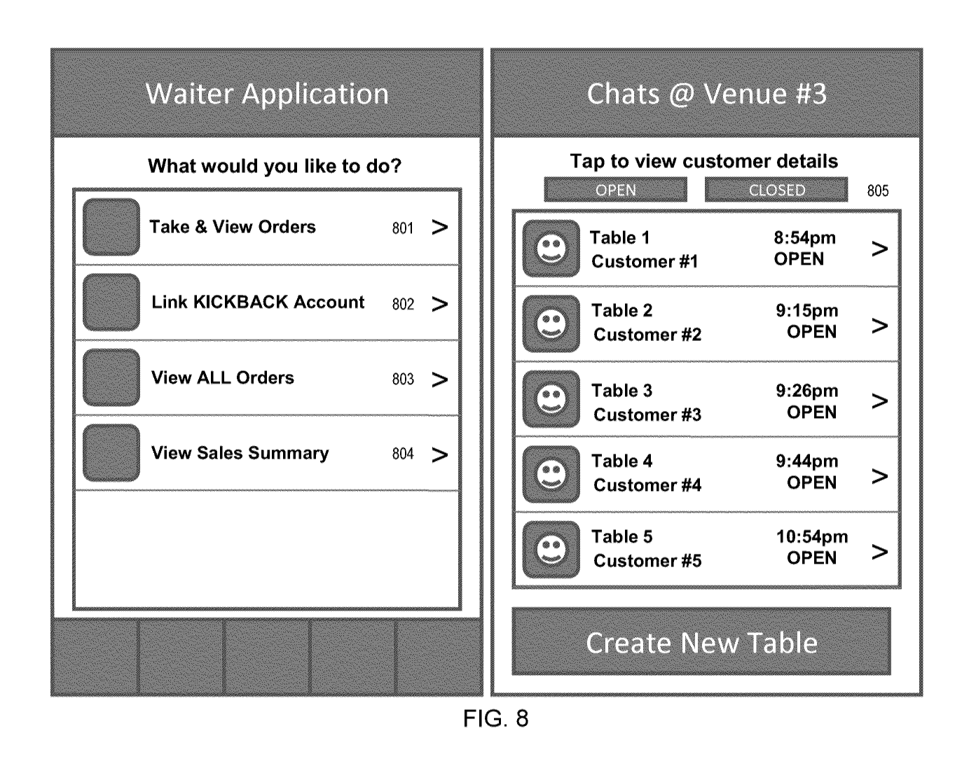

Referring to FIG. 8, a waitress at a venue may also utilize embodiments of the mobile application in the form of a waitress application to take a consumer's order. Certain venues may elect to not allow consumers to use mobile application to place an order. Instead (or in addition), a waitress application may be utilized to process orders. The waitress may be able to navigate a menu 801 and select items that a consumer would like to order. A waitress may also define appropriate modifiers, for example “methods of preparation,” to the items that have been ordered. For example, a waitress may ask consumers how they want their eggs prepared—scrambled, poached, or sunny-side up. In addition, the waitress can associate a consumer's account with the order she is taking 802 by entering the consumer's cell phone number while taking the order. This may allow the consumer to associate this order with their mobile ordering application account, so the receipt appears in their account and can be accessed via an online portal for the consumer, a social media application for consumers (such as a Facebook application), or other various mobile interfaces, such as iPhone, BB, Palm, Windows, etc. Also, in this scenario, a consumer may use credits that they may have in their account toward the order. When the waitress enters the cell phone number of a consumer, the system may automatically deduct credits that they have on file and the consumer can also pay with their account credits or file information by entering their personal 4 digit PIN on the waitress application. Thus, the consumer may be able to use the mobile ordering application without having their mobile device on them because, in this scenario, the transaction may be handled by a waitress's mobile application.

The waitress or waiter application may also allow a server to view all of the orders that the waitress or waiter has taken 803 or view reports such as a sales summery 804 over a certain time period. The waiter or waitress may also keep track of all of the tables that he or she is serving as in 805, and be able to view details of each customer, the time that the customer was seated or that the order was taken, and whether the customer is still seated at the table, waiting for their order, or other status information.

The mobile ordering system may also provide reporting capabilities. Merchants may have visibility into all of the order information that is processed from their customers. For example, a merchant may have access to information that details who is visiting their establishment, what they are buying, how much-they are spending, how often they are coming in, etc. A merchant may now have a more complete understanding of a lifetime value of its customers and have an opportunity to increase that value by proactively using the mobile ordering system's features to extend promotional deals, discounts, etc. to certain consumers.

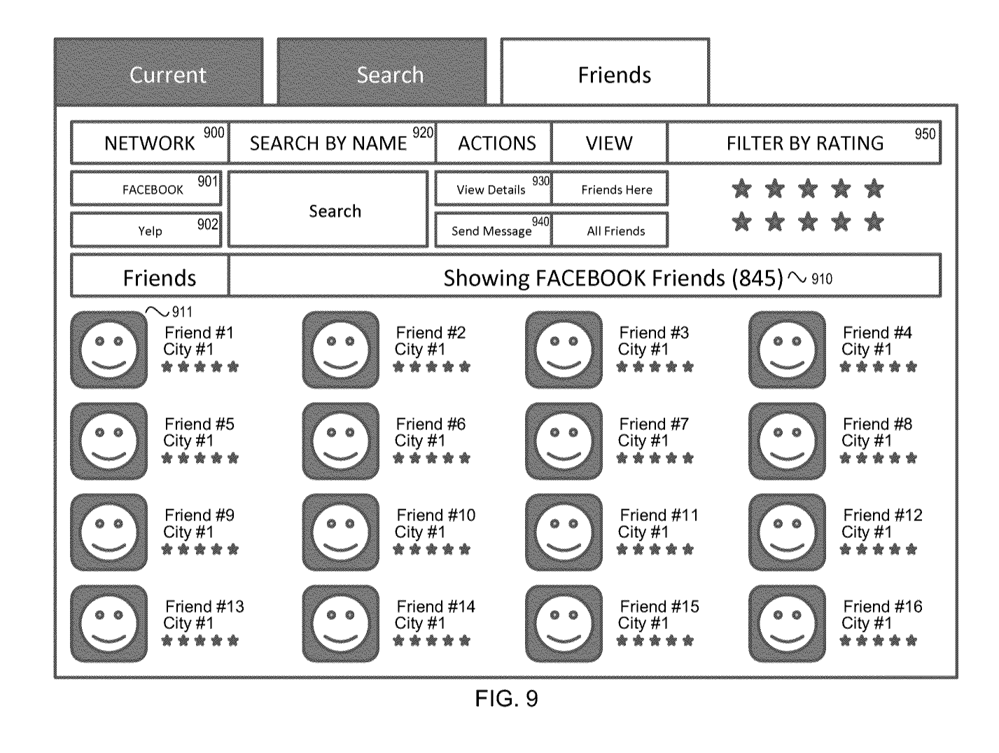

Referring to FIG. 9, the mobile ordering application system may also leverage information and features from various social networking sites, such as Facebook, Yelp, etc. With the consumer's mobile application and a merchant's communication display application, the mobile ordering application system may aggregate a venue's Facebook Fan page, for example, with the venue's mobile ordering application account, to provide a complete view for a customer. For example, many venues have created Facebook fan pages so they have another channel to be able to reach out to their customers. The problem that many venues have is that there may be no efficient, accurate or honest way to capture (and confirm) whether a person visited their establishment. Further, a venue may not be able to determine which of their Facebook fans and/or consumers purchased items or services while visiting the venue.

The mobile ordering application may aggregate various social networks 900 such as Facebook 901 and Yelp 902. Various “friends” or members within a certain social network 910 may be displayed. Each friend 911 may be associated with a name, location, profile or other picture and rating. The rating may represent the user's star rating, as further described below. The display may allow the viewer to search users by name 920, view details of other users 930, send messages to other users 940, filter users by rating 950, etc.

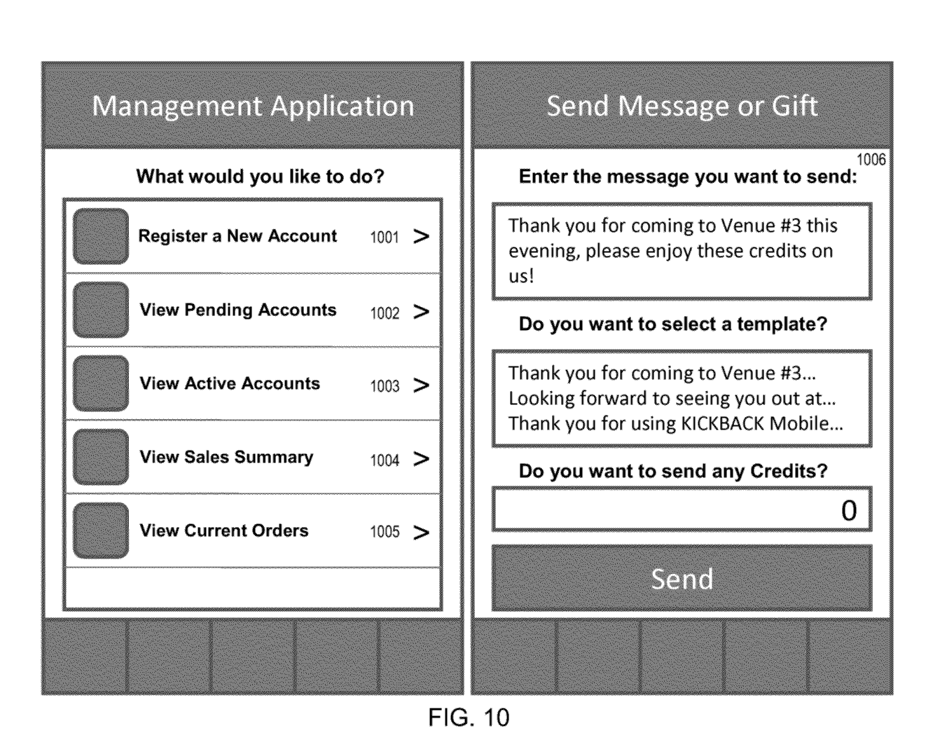

Referring to FIG. 10, a management application may also be used by a venue's manager or owner to keep track of and improve their customer's experiences at the venue. For example, the management application may be used to register new accounts 1001, view pending accounts 1002, view active accounts 1003, view an overall sales summary 1004, or view current orders at a venue 1005. It may be difficult for a venue's personnel to keep mental tabs on what customers come in. Servers or waiters may not track or document who is visiting an establishment and how much each person is spending; it may not be in their job description and they may not have any motivation or incentive to do so. Thus, important information regarding a venue's consumers and visitors may be lost and management may not have the visibility that it requires to target and cater to the customers that patronize them the most, have an opportunity to win customers (who have had a bad experience) back, or invite certain customers who are likely going to spend $100 a week back to their venue week after week. While current operators may have a short term strategy of, “What will I make tonight?” the mobile application ordering system may redefine that strategy. For example, the mobile application ordering system may help a venue understand that, in a given evening, they may have 50 customers, each of which spend $100; but instead considering these customers as $100 customers, the venue can instead value them as $5200 customers because those customers are likely to spend $100 somewhere each week. The mobile ordering application system may provide an opportunity for venues to capture and organize their customer data for venues, which may allow them the ability to stay in touch with customers when they leave their venue and invite them back to experience the venue again—all while not depending on their personnel (where attrition is so high) to visually recognize the customers from a previous experience.

The system's management mobile application may also allow venue managers to remotely view all of the transactions at their venue in real time 1005. For example, a venue manager may be at home or may be managing another venue. Through the management mobile application, the venue manager or owner may view a summary of transaction information 1004 and may be notified when certain consumers have achieved a certain spend threshold or have purchased a particular item, or how much revenue a certain waitress has processed. Various types of alerts may be defined by a rules engine. The management mobile application may also have the ability for managers to be able to communicate directly with consumers by sending them a message, similar to text messaging. Managers may also be able to associate credits with the message and provide or gift them to the consumer 1006. For example, if a consumer has just spent $100, a manager may provide or gift that consumer with another $10 credit to keep the consumer at the venue to spend more, or give the consumer credits to show the venue's appreciation for the consumer's business. The management application may also allow the manager to modify the menu of items that are available, along with other details including names of items or services, description, pricing, specials, pick-up locations, etc.

The mobile ordering system may include a communication appliance that is a device that receives orders (or requests) from a consumer application and waitress application. An operation may see the time elapsed of the order (the running time of how long an order has been in the queue), the items in the order, who placed the order (a customer's name), the customer's star rating, etc. For example, a customer's “Red” star rating may be a star rating that is calculated based on spending within the mobile application's network, and perhaps a “Gold” star rating may be based on spending at a particular venue. An operator may also be able to view the location where the order will be redeemed (either at a pickup location or at a delivery location). The operator may also have actionable choices such as a cancel button, which cancels an order and refunds the customer the amount paid; a complete button, which completes or places the order in the completed state and commands the printer to print a receipt for the order and registers a completion time; a hold button, which allows the operator to temporarily pause an order (but perhaps not pause the time), where the order is kept in its current place in the queue; a more info button, which displays additional information on the customer who has made a purchase, such as, order #, last 4 digits of the customer's cell number, payment type, or if there is a room number or other information associated with the order. In addition, the system may display a “modified” label on an order (for example, if the consumer has decided to modify an item on the order, such as “hold the mayo”). These “modified” instructions may appear when the operator selects the item, then a popup dialog box may appear communicating the details of that item, including the modified instructions, and the ingredients.

On an order screen, the operator may select the on the name of the customer, where the customer profile dialog box appears, where the operator can see details of the customer. A customer's picture, network, order history, birthday, and home location may also be viewable. The operator may be able to send a customer a message, by selecting a message button. Upon selecting a message button a popup may appear where the operator can select the appropriate message to send out to the customer, and even indicate an amount that they'd like to credit their account or gift them. The operator can also search for orders in the system by order #, last 4 digits of cell number, etc. Searching may allow an operator to identify an order that may require refunding, or identify a consumer who is a “no show”, or take actions such as “suspend” ordering privileges on a consumer in question. Suspension can be based on suspicious activity, intoxication, no show, or under 21 years of age. A consumer may be required enter a date of birth that is 21 years or older in order to see alcoholic beverages in the system.

The communication appliance may also allow an operator to print a receipt again if the customer requests it. In addition, the operator may have the ability to “pause” (or hold) ordering. This feature may be used in the event that a queue is full of orders. The operator then may select Pause so that no more orders will go through and the current orders can be processed and completed. When a consumer attempts to place a new order after the operator has selected “pause,” the system may respond with, “The wait time for orders is too high, please place your order with the waitress” or “We currently have a lot of orders to complete, it may make more sense for you to place your order with the waitress.” The operator may also have the ability to see reports on all the orders in the system by date and have the ability to print out sales reports through the system, such as Subtotal, total tax, total discounts, total credits, total service charges, total gratuity, total sales per category, etc. The operator may also have the ability to manage the menu and inventory for items, prices, remove discounts, define time for discounts, define pickup locations, etc.

An operator or manager may also have the ability to create and edit a venue's fan page from social networking sites such as Facebook and Yelp (as shown previously in FIG. 9). In this manner, various customers' profiles may be integrated with corresponding Facebook or Yelp customer profiles, thus providing a more complete view of the customers. Further, important statistics may be analyzed, such as the percentage of Facebook fans that use mobile ordering application, or the total spending by a venue's Facebook fans. A venue may be able to analyze whether its Facebook fan page is actually driving people to making a purchase at the venue, whether customers took advantage of a certain special or invitation offered on a social networking site, etc.

The mobile ordering application may leverage the power of social networking within a touch computing experience (as shown previously in FIG. 9). Further, the mobile ordering application may allow a social networking site, such as a Facebook fan page, to be more accessible and increase the probability of it being more utilized—with the goal of reaping more value from the social networking channel.

An interface may be created between a social networking site and the mobile ordering application. For example, Facebook credentials may be entered through the mobile ordering application. The Facebook credentials may allow the mobile ordering application to place a request, via the Facebook API and pull the information into the mobile ordering application. Fan information from Facebook may be populated into the mobile ordering application, along with pictures, network information, phone numbers of users, etc. from Facebook. If an operator wants to filter the list the operator may be able to select “Filter.” A dialog box may appear where the operator may be able to filter the list by Home town, Network, birth date, etc. Thus, managers or other operators of the venue may be able to send targeted messages or gifts via the mobile ordering application to these individuals. For example, a venue's manager may congratulate a person on a birthday by sending them a message (and gift credits) or an invite a potential customer to visit their establishment and enjoy food, beverage, or other amenities or services. For example, a message may be sent to a user Todd that says, “Happy Birthday Todd! Here's $10 in credits for you to use next time you come to The Ambassador. Expires on 02-15-2010.”

The mobile ordering application may also provide the ability for retailers to manage their inventory in real time. As a consumer makes purchases, the system may automatically deduct the number of items that appear in the inventory. When the number of items falls under a certain threshold, a notification may be sent to the manager to order more of a specific item, through a text message or through the management application. In addition, an alert dialog message may appear on the venue's communication computer, to notify a fulfiller that the venue is running low or out of the specific item. The system may provide a few options for configuration: 1) the system may automatically remove an item from the menu for the consumer, so the consumer isn't able to select it; or 2) the system may keep the item in the menu and then as a consumer selects the item, it may display a message indicating that the item is out of inventory, and suggest another item (through the alternate sell functionality). Thus, the retailer may be able to better understand how revenue was potentially lost and may better plan inventory as per a given day. Further, a merchant may utilize the system to automatically notify a supplier to provide a shipment of the product in question.

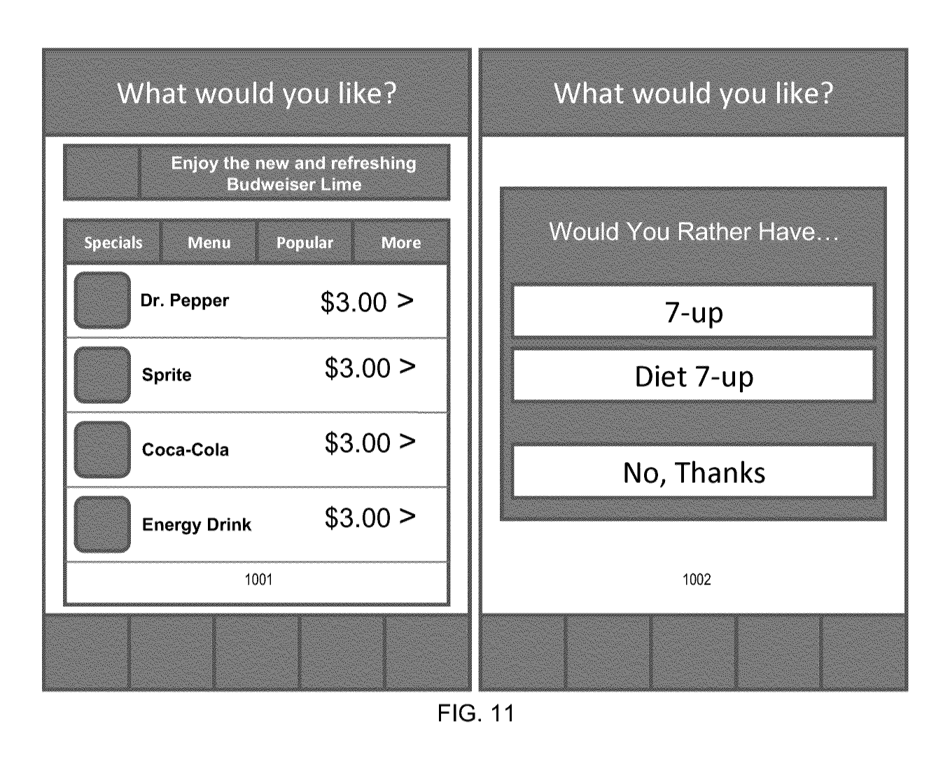

Referring to FIG. 11, an advertiser may also utilize the mobile ordering application to create advertising campaigns at the point of purchase (such as brand interception), while automatically measuring the effectiveness of these advertising campaigns by analyzing impressions and conversions.

For example, the mobile ordering application may allow consumer's to engage in one tap ordering 1101. Advertisers may place certain products in an “express lane” type of purchase option. Upon selecting the item, the mobile ordering application may bypass all of the other steps, configurations and selections and just prompt the consumer to enter their PIN, for example.

In addition, an advertiser or merchant may engage in brand or item interception 1102. The mobile ordering application system may provide the ability for advertisers to purchase “words” at the point of purchase. For example, through the ad marketplace application, an advertiser (such as Joe's pizza) can purchase a word, such as “pizza.” Now, when the consumer selects pizza from a menu, it will display the “Joe's Pizza” rather than a generic “pizza”. In another example, “Joe's pizza” may buy the word “Tom's Pizza,” and when a consumer selects “Tom's pizza” the system may display an option, “Would you rather have Joe's Pizza?” Thus, Joe's Pizza may have the opportunity to steal Tom's pizza sale. In the example shown in FIG. 11, if the customer is about to purchase a “Sprite” an advertiser may display a prompt that asks the user whether they would rather have a “7-up” or “Diet 7-up.”

In addition, the mobile ordering system may provide the ability for advertisers to see a complete transaction history for a given time frame for certain consumers. Advertisers and merchants may be able to see real time feedback on ad campaigns and whether any given campaign leads to conversion of an actual sale.

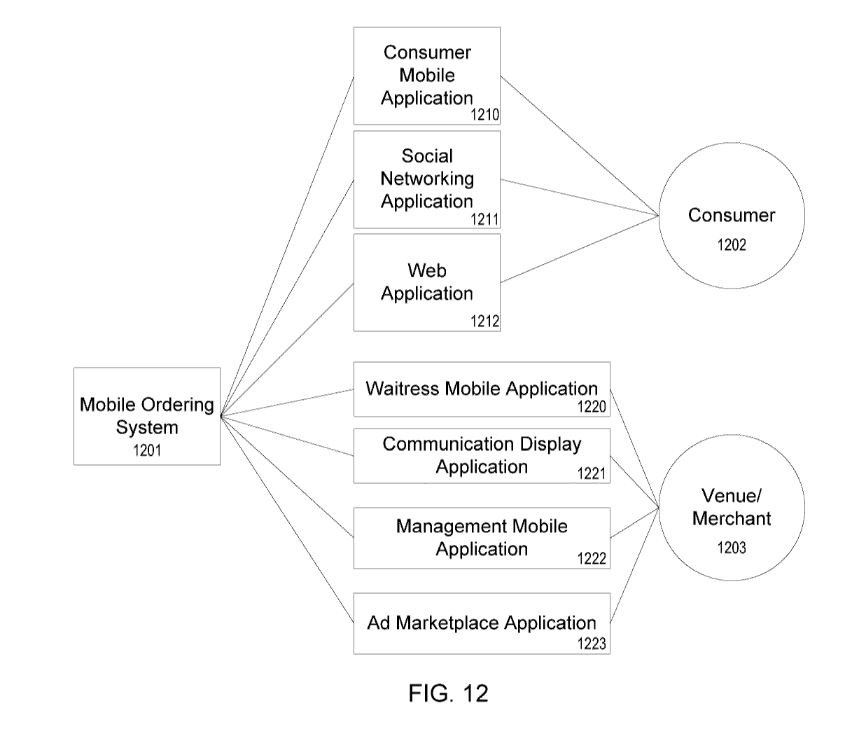

Referring to FIG. 12, various users may interact with the mobile ordering system 1201 as described above, including consumers 1202 and individuals representing a venue or a merchant 1203. Consumers 1202 may access the mobile ordering system 1201 through a consumer's mobile device using a consumer mobile application 1210. Consumers 1202 may also access the mobile ordering system 1201 through a social networking application 1211 or a web application 1212. Representatives of venues and merchants 1203 may include waiters and waitresses, managers, owners, advertisers, etc. and may access the mobile ordering system 1201 through various means including a waitress mobile application 1220, a communication display application 1221, a management mobile application 1222, or an ad marketplace application 1223, as described above. Various types of users may be able to utilize different features of the mobile ordering system through different types of applications, not limited to as shown in the figures or described above. For example, an advertiser may utilize the management mobile application 1222 or ad marketplace application 1223. There may also be other features and situations in which a consumer 1202 who is at a venue uses the waitress mobile application 1220 or communication display application 1221.

All concepts of the invention may be incorporated or integrated with other systems and methods of mobile ordering, including but not limited to those described in U.S. Patent Publication No. 2008/0040233 (Wildman et al.) published on Feb. 14, 2008, U.S. Patent Publication No. 2006/0218040 (Sabapathypillai) published on Sep. 28, 2006 and U.S. Patent Publication No. 2004/0129770 (Masuno) published on Jul. 8, 2004, which are hereby incorporated by reference in their entirety.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

While this invention has been described and illustrated with reference to particular embodiments, it will be readily apparent to those skilled in the art that the scope of the invention is not limited to the disclosed embodiments but, on the contrary, is intended to cover numerous other modifications and equivalent arrangements which are included within the spirit and scope of the following claims.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc. Furthermore, aspects of the systems and methods may be embodied in microprocessors having software-based circuit emulation, discrete logic (sequential and combinatorial), custom devices, fuzzy (neural network) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof Examples of transfers of such formatted data and/or instructions by carrier waves include, but are not limited to, transfers (uploads, downloads, email, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the invention are not described with reference to any particular processor, programming language, machine code, etc. It will be appreciated that a variety of programming languages, machine codes, etc. may be used to implement the teachings of the invention as described herein.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’ Words using the singular or plural number also include the plural or singular number respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventor contemplates the various aspects of the systems and methods in any number of claim forms. Accordingly, the inventor reserves the right to add additional claims after filing the application to pursue such additional claim forms for other aspects of the systems and methods.

1. A mobile application ordering system for processing orders at a retail venue comprising:
a consumer mobile application accessible through a consumer's mobile device for allowing a consumer to place an order for a retail item; and
an administrative portal for allowing the retail venue to receive and process the order for the retail item from the consumer;
wherein the order is transmitted from the consumer's mobile device to the administrative portal over a network;
wherein the consumer mobile application allows the consumer to communicate with at least one other consumer at the retail venue;
wherein the administrative portal allows a representative from the retail venue to track data relating to a plurality of spending behavior of the consumer and a plurality of preferences of the consumer; and
wherein the representative utilizes said tracked data to send a message to the consumer.

2. The mobile application ordering system of claim 1, wherein said tracked data is provided to an advertiser.

3. The mobile application ordering system of claim 1, wherein the retail item is made available by the retail venue for pickup or delivery based on the plurality of preferences of the consumer.

4. The mobile application ordering system of claim 1, wherein the message is a digital gift from the retail venue.

5. The mobile application ordering system of claim 1, wherein the message is an advertisement.

6. The mobile application ordering system of claim 1, wherein the message is a coupon for a discount on a retail item.

7. The mobile application ordering system of claim 1, wherein the consumer mobile application allows the consumer to send a digital gift to another consumer at the retail venue.

8. The mobile application ordering system of claim 7, wherein the digital gift is in the form of credits which may be used for making purchases at the retail venue.

9. The mobile application ordering system of claim 7, wherein the digital gift is in the form of credits which may be used for making purchases one or more retail venues.

10. The mobile application ordering system of claim 1, wherein the retail venue receives a plurality of orders via the administrative portal and matches similar orders for fulfillment.

11. The mobile application ordering system of claim 1, wherein the consumer mobile application allows the consumer to view other consumers in a social network physically located at the retail venue.

12. The mobile application ordering system of claim 1, wherein the consumer is physically located at the retail venue and the consumer mobile application allows the consumer to view other consumers in a social network also physically located at the retail venue.

13. The mobile application ordering system of claim 1, wherein the consumer participates in a loyalty program and earns points for the retail item purchased at the retail venue.

14. The mobile application ordering system of claim 13, wherein the consumer mobile application tracks the points earned by the consumer.

15. The mobile application ordering system of claim 1, wherein the retail item is a food or beverage and the consumer mobile application matches the retail item to the food or beverage in a calorie database and tracks a total number of calories consumed by the consumer.

16. The mobile application ordering system of claim 1, wherein the administrative portal displays a list of current orders from a plurality of consumers, a time that has elapsed since each order was placed by each consumer, a list of contents for each order, a consumer name for each order, and a location for each consumer.

17. A method for processing orders at a retail venue comprising:
providing a plurality of consumers access to a mobile application accessible through a plurality of mobile devices;
providing an administrative portal for displaying a list of received orders, a time that has elapsed since each order was received, a list of retail items requested in each order, a consumer name for each order, and a location for each consumer;
receiving orders for one or more retail items from the plurality of consumers placed through the plurality of mobile devices;
transmitting from the plurality of mobile devices to the administrative portal over a network;
receiving one or more communications from a first consumer to a second consumer;
transmitting the one or more communications from a mobile device of the first consumer to a mobile device of the second consumer;
tracking a plurality of spending behavior of the plurality of consumers and a plurality of preferences of the plurality of consumers; and
utilizing the plurality of spending behavior to send a message to one or more consumers.

18. The method of claim 17, further comprising fulfilling the orders for one or more retail items by aggregating and processing similar orders.

19. The method of claim 17, wherein the message is a coupon, discount, rebate, offer for upgrade, digital gift, promotion, invitation, or credit.

20. A computer-usable medium having computer readable instructions stored thereon for execution by a processor to perform a method for processing orders at a retail venue comprising:
providing a plurality of consumers access to a mobile application accessible through a plurality of mobile devices;
providing an administrative portal for displaying a list of received orders, a time that has elapsed since each order was received, a list of retail items requested in each order, a consumer name for each order, and a location for each consumer;
receiving orders for one or more retail items from the plurality of consumers placed through the plurality of mobile devices;
transmitting from the plurality of mobile devices to the administrative portal over a network;
receiving one or more communications from a first consumer to a second consumer;
transmitting the one or more communications from a mobile device of the first consumer to a mobile device of the second consumer;
tracking a plurality of spending behavior of the plurality of consumers and a plurality of preferences of the plurality of consumers; and
utilizing the plurality of spending behavior to send a message to one or more consumers.
